(19) United States
(12) Patent Application Publication
(10) Pub. No.: US 2022/0338494 A1
(43) Pub. Date: Oct. 27, 2022

(54) COMPOSITIONS AND METHODS FOR PREVENTING AND/OR REDUCING MELANOSIS IN CRUSTACEANS

(71) Applicant: CSP Technologies, Inc., Auburn, AL (US)

(72) Inventors: Kathryn Perko, Auburn, AL (US); Jason Pratt, Auburn, AL (US); Neal D. Watson, Atlanta, GA (US)

(21) Appl. No.: 17/596,586

(22) PCT Filed: Jun. 17, 2020
(86) PCT No.: PCT/US2020/038181

§ 371 Date: Dec. 14, 2021

Related U.S. Application Data
(60) Provisional application No. 62/864,452, filed on Jun. 20, 2019.

(51) Int. Cl. A23B 4/16; B65D 81/28; A23B 4/20; A23L 3/3472; A01K 61/59

(52) U.S. Cl. CPC A23B 4/16; B65D 81/28; A23B 4/20; A23L 3/3472; A01K 61/59; A23V 2002/00

(57) ABSTRACT

Disclosed are anti-melanosic releasing agents, anti-melanosic systems, and methods of preventing or reducing melanosis in crustaceans, particularly shrimp. Melanosis in shrimp is prevented or reduced by exposing shrimp to the anti-melanosic system containing the anti-melanosic releasing agent, e.g., green tea.

### CROSS-REFERENCE TO RELATED APPLICATIONS

This application claims priority to U.S. Provisional Patent Application No. 62/864,452, filed Jun. 20, 2019, entitled “COMPOSITIONS AND METHODS FOR PREVENTING AND/OR REDUCING MELANOSIS IN CRUSTACEANS”, the contents of which are incorporated herein by reference in their entirety.

### BACKGROUND OF THE INVENTION

### 1. Field of Invention

This invention relates to an agent, a system and a method of reducing and preventing melanosis in crustaceans, e.g., shrimp. For example, the invention relates to use of green tea and volatiles emitted therefrom for reducing and/or preventing melanosis in shrimp.

### 2. Description of Related Art

Fish and fishery products are among the most traded food commodities worldwide. Among these products, crustaceans have great economic importance in many countries across the globe. Melanosis represents a serious problem to the crustaceans industry. Melanosis, or as it is commonly known “black spot”, is a very common problem in crustaceans during post-harvest storage. It occurs due to biochemical reactions catalyzed by polyphenol oxidases (PPO) enzymes, dark pigments called melanin are created and gather chiefly under the carapace of the cephalothorax. Although melanosis causes no direct harm to consumers, it damages the sensory features of crustaceans, decreasing their quality, shelf life, and subsequently, their commercial value.

In order to avoid great economic losses, different preservation methods are used and studied to prevent melanosis. Techniques such as slurry ice treatment with an anti-melanosic agent, precooking, modified atmosphere packaging—MAP, and 4-hexylresorcinol (4-HR) have been extensively investigated and present different levels of anti-melanosic activity. Nowadays, there is market demand for healthier, less additive-filled products, natural alternatives to common melanosis inhibitors.

### SUMMARY OF THE INVENTION

Accordingly, in one aspect, the invention provides an anti-melanosic releasing material for preventing and reducing melanosis in crustaceans. Optionally, the crustaceans are shrimp. The anti-melanosic releasing material comprises at least one of Camellia sinensis leaves and Camellia sinensis buds or an extract therefrom. Optionally, the Camellia sinensis leaves and Camellia sinensis buds are of a green tea. Optionally, the green tea leaves or buds are in a powder form.

Accordingly, in one aspect, the invention provides an entrained polymer comprising a base polymer and an anti-melanosic releasing material. Optionally, the entrained polymer further comprises a channeling agent.

Accordingly, in one aspect, the invention provides an anti-melanosic system for preventing and reducing melanosis in crustaceans. Optionally, the anti-melanosic system comprises an anti-melanosic releasing material. Optionally, the anti-melanosic system comprises an entrained polymer comprising a base polymer, an anti-melanosic releasing material. Optionally, the anti-melanosic system comprises an entrained polymer comprising a base polymer, an anti-melanosic releasing material, and a channeling agent. Optionally, the anti-melanosic system further comprises a container.

Optionally, the anti-melanosic system comprises an anti-melanosic releasing material, wherein the anti-melanosic releasing material comprises at least one of Camellia sinensis leaves and Camellia sinensis buds. Optionally, the anti-melanosic system further comprises a container.

The anti-melanosic system comprises an anti-melanosic releasing material and, optionally, a sorbent composition of matter, herein referred to interchangeably as a sorption material or absorbent material. This sorbent composition of matter has an absorbency or adsorbency, which terms are used interchangeably herein, the absorbency being defined by weight of liquid absorbed/weight of the absorbent composition of matter. The absorbent composition of matter includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; (ii) at least one mineral composition having a second absorbency, the second absorbency being defined by weight of liquid absorbed/weight of the at least one mineral composition, the at least one mineral composition being food safe; and (iii) at least one soluble salt having at least one trivalent cation, the at least one soluble salt having at least one trivalent cation being food safe, the absorbency of the absorbent composition of matter exceeding a sum of the first absorbency and the second absorbency the absorbent composition of matter being compatible with food products such that the absorbent composition of matter is food safe when in direct contact with the food products. The anti-melanosic releasing agent, e.g., green tea, may be mixed in with the absorbent material or is alternatively provided separately.

In another aspect, the invention provides a method for preventing and reducing melanosis in crustaceans. In one optional embodiment, the method comprises the step of exposing the crustaceans to the anti-melanosic releasing material. In one optional embodiment, the method comprises the step of exposing the crustaceans to the anti-melanosic releasing system.

In one optional embodiment, the method for preventing and reducing melanosis in crustaceans comprises the step of exposing the crustaceans to the entrained polymer. In another optional embodiment, the method comprises the step of storing the crustacean in the anti-melanosic system. During storage, the released anti-melanosic agent prevents and reduces melanosis in the crustaceans.

In another aspect, the invention provides a method for preventing and reducing melanosis in crustaceans. In one optional embodiment, the method comprises the step of exposing the crustaceans to the anti-melanosic releasing material or the anti-melanosic releasing system. In another optional embodiment, the method comprises the step of storing the crustacean in the presence of the anti-melanosic releasing material or the anti-melanosic releasing system. During storage, the released anti-melanosic agent prevents and reduces melanosis in the crustaceans.

Optionally, in any embodiment, the stored crustaceans, e.g., shrimp, are non-living.

Optionally, in any embodiment, the anti-melanosic releasing material, e.g., green tea, generates a volatile component into air adjacent to the crustaceans that prevents melanosis on the crustaceans, wherein such melanosis prevention does not depend on direct physical contact between the anti-melanosic releasing material and the crustaceans.

### BRIEF DESCRIPTION OF THE DRAWINGS

The invention will be described in conjunction with the following drawings in which like reference numerals designate like elements and wherein:

FIG. 1 is a perspective view of a plug formed of an entrained polymer that may be deposited onto a substrate or within a package or seafood display case according to methods of the disclosed concept.

FIG. 2 is a cross section taken along line 2-2 of FIG. 1.

FIG. 3 is a cross section similar to that of FIG. 2, showing a plug formed of another embodiment of an entrained polymer according to an optional embodiment of the present invention.

FIG. 4 is a schematic illustration of an entrained polymer according to an optional embodiment of the present invention, in which the active agent is a volatile releasing material.

FIG. 5 is a cross sectional view of a sheet or film formed of an entrained polymer according to an optional embodiment of the present invention, adhered to a barrier sheet substrate.

FIG. 6 is a cross section of a package that may be formed using an entrained polymer according to an optional embodiment of the present invention.

FIG. 7 is a perspective view of an exemplary package incorporating entrained polymer films according to an optional aspect of the present invention.

FIG. 8 is a top plan view of an anti-melanosic article made according to an optional embodiment of the present invention.

FIG. 9 is a side elevational view of the article of FIG. 8.

FIG. 10A is a photograph of a flexible package of shrimp according to an optional package form usable in conjunction with the invention.

FIG. 10B is a photograph of the package of 10A opened up and including an entrained polymer film comprising green tea, according to an optional embodiment of the invention.

FIG. 11A is a photograph of shrimp stored at 4° C. after 4 days with no anti-melanosic entrained polymer film, as a control.

FIG. 11B is a photograph of shrimp stored at 4° C. after 4 days with anti-melanosic entrained polymer film having a Tyvek® backing film on one side.

FIG. 11C is a photograph of shrimp stored at 4° C. after 4 days with anti-melanosic entrained polymer film having no Tyvek® backing film.

FIG. 12A is a photograph of raw, headless, shell-on shrimp stored at 4° C. after 5 days, using an optional embodiment of the anti-melanosic system.

FIG. 12B is a photograph of raw, headless, shell-on shrimp stored at 4° C. after 5 days, using no anti-melanosic system, acting as a control sample for the shrimp group shown in FIG. 12A for melanosis comparison.

FIG. 13A is a close-up photograph of a representative sample of shrimp selected from those of FIG. 12A.

FIG. 13B is a close-up photograph of a representative sample of the control group of shrimp of FIG. 12B, highlighting melanosis spots on the shrimp.

FIG. 14A is a photograph of raw, peeled, deveined, deshelled, tail-on shrimp stored at 4° C. after 5 days, using an optional embodiment of the anti-melanosic system.

FIG. 14B is a photograph of raw, peeled, deveined, deshelled, tail-on shrimp stored at 4° C. after 5 days, using no anti-melanosic system, acting as a control sample for the shrimp group shown in FIG. 14A for comparison, showing a difference in coloration of the shrimp.

FIG. 15A is a close-up photograph of a representative sample of shrimp selected from those of FIG. 14A.

FIG. 15B is a close-up photograph of a representative sample of the control group of shrimp of FIG. 14B, showing some melanosis spots on the shrimp compared to the shrimp group of FIG. 15A.

FIG. 16A is a photograph of cooked, peeled, deveined, deshelled, tail-on shrimp stored at 4° C. after 5 days, using an optional embodiment of the anti-melanosic system.

FIG. 16B is a photograph of cooked, peeled, deveined, deshelled, tail-on shrimp stored at 4° C. after 5 days, using no entrained anti-melanosic system, acting as a control sample for the shrimp group shown in FIG. 16A for comparison showing a slight variation in the shade or color of the shrimp.

FIG. 17A is a close-up photograph of a representative sample of shrimp selected from those of FIG. 16A.

FIG. 17B is a close-up photograph of a representative sample of the control group of shrimp of FIG. 16B, showing darker tails on the shrimp as compared to the shrimp group of FIG. 17A.

### DETAILED DESCRIPTION OF PREFERRED EMBODIMENTS OF THE INVENTION

### Definitions

As used herein, the term “active” is defined as capable of acting on, interacting with or reacting with a selected material (e.g., moisture or oxygen) according to the invention. Examples of such actions or interactions may include absorption, adsorption or release of the selected material. Another example of “active”, which is pertinent to a primary focus of the present invention is an agent capable of acting on, interacting with or reacting with a selected material in order to cause release of a released material.

As used herein, the term “active agent” is defined as a material that (1) is preferably immiscible with the base polymer and when mixed and heated with the base polymer and the channeling agent, will not melt, i.e., has a melting point that is higher than the melting point for either the base polymer or the channeling agent, and (2) acts on, interacts or reacts with a selected material. The term “active agent” may include but is not limited to materials that absorb, adsorb or release the selected material(s). The active agents of primary focus in this specification are those that release an anti-melanosic material.

The term “anti-melanosic releasing agent” refers to an active agent that is capable of releasing an anti-melanosic component. The term “anti-melanosic releasing agent” may be used interchangeably with the term “anti-melanosic releasing material.” This active agent may include an active component and other components in a formulation (e.g., powdered mixture) configured to release the anti-melanosic component. An “anti-melanosic component” is a compound that inhibits or prevents the formation of melanosis in crustaceans. The anti-melanosic component is released by the anti-melanosic releasing agent. By way of example only, an anti-melanosic releasing agent may be triggered (e.g., by chemical reaction or physical change) by contact with a selected material (such as moisture). For example, moisture may dissolve the anti-melanosic material and cause the anti-melanosic releasing agent to release the anti-melanosic component. An anti-melanosic releasing agent may also voluntarily release the anti-melanosic component without a trigger, e.g., in dry conditions. Specifically, the anti-melanosic releasing material comprises at least one of Camellia sinensis leaves, Camellia sinensis buds or an extract therefrom. Optionally, the Camellia sinensis leaves, Camellia sinensis buds or the extract are of a green tea. Optionally, the green tea leaves or buds are in a powder form.

As used herein, the term “base polymer” is a polymer used to provide structure for the entrained polymer. The base polymer is preferably capable of being extruded or molded to form an entrained polymer comprising an anti-melanosic agent. In the case of a three phase entrained polymer (comprising a base polymer, anti-melanosic agent and channeling agent), the base polymer optionally has a gas transmission rate of a selected material that is substantially lower than, lower than or substantially equivalent to, that of the channeling agent. By way of example, such a transmission rate is a transmission rate of air and/or anti-melanosic volatile material in some embodiments. This active agent may include an active component and other components in a formulation configured to release the anti-melanosic material.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

In certain embodiments, the channeling agent has a water vapor transmission rate of at least two times that of the base polymer. In other embodiments, the channeling agent has a water vapor transmission rate of at least five times that of the base polymer. In other embodiments, the channeling agent has a water vapor transmission rate of at least ten times that of the base polymer. In still other embodiments, the channeling agent has a water vapor transmission rate of at least twenty times that of the base polymer. In still another embodiment, the channeling agent has a water vapor transmission rate of at least fifty times that of the base polymer. In still other embodiments, the channeling agent has a water vapor transmission rate of at least one hundred times that of the base polymer.

As used herein, the term “channels” or “interconnecting channels” is defined as passages formed of the channeling agent that penetrate through the base polymer and may be interconnected with each other.

As used herein, the term “entrained polymer” is defined as a monolithic material formed of at least a base polymer, an active agent and optionally also a channeling agent entrained or distributed throughout. An entrained polymer thus comprises at least two phases (without a channeling agent) or at least three phases (with a channeling agent).

As used herein, the term “extract” refers to any compounds processed or derived from the Camellia sinensis plant (leaves, buds, or stems) that has antioxidant properties, including, but not limited to flavonoids, vitamins and polyphenols such as epigallocatechin-3-gallate (EGCG) and other catechins. The extract herein is optionally obtained by, for example, by boiling in water the tea leaves or buds or by cold brewing the leaves or buds to form a tea solution with catechin components therein. The tea solution may be further processed resulting in a solid powder form of the catechin compounds. Various processes for obtaining tea extracts are known. A myriad of tea extracts are commonly commercially available and are optionally operable within the scope of the anti-melanosic system and methods herein.

As used herein, the term “monolithic,” “monolithic structure” or “monolithic composition” is defined as a composition or material that does not consist of two or more discrete macroscopic layers or portions. Accordingly, a “monolithic composition” is not a multi-layer composite, but could optionally be part of such a component.

As used herein, the term “phase” is defined as a portion or component of a monolithic structure or composition that is uniformly distributed throughout, to give the structure or composition its monolithic characteristics.

As used herein, the term “selected material” is defined as a material that is acted upon, by, or interacts or reacts with an active agent and is capable of being transmitted through the channels of an entrained polymer. For example, in embodiments in which a releasing material is the active agent, the selected material may be moisture that reacts with or otherwise triggers the active agent to release a releasing material, such as an anti-melanosic component.

As used herein, the term “three phase” is defined as a monolithic composition or structure comprising three or more phases. An example of a three phase composition according to the invention is an entrained polymer formed of a base polymer, active agent, and channeling agent. Optionally, a three phase composition or structure may include an additional phase, e.g., a colorant, but is nonetheless still considered “three phase” on account of the presence of the three primary functional components.

Furthermore, the terms “package,” “packaging” and “container” may be used interchangeably herein to indicate an object that holds or contains a good, e.g., food product and foodstuffs. Optionally, a package may include a container with a product stored therein. Non-limiting examples of a package, packaging and container include a tray, box, carton, display case, bottle receptacle, vessel, pouch and flexible bag. A pouch or flexible bag may be made from, e.g., polypropylene or polyethylene. The package or container may be closed, covered and/or sealed using a variety of mechanisms including a cover, a lid, lidding sealant, an adhesive and a heat seal, for example. The package or container is composed or constructed of various materials, such as plastic (e.g., polypropylene or polyethylene), paper, Styrofoam, glass, metal, wood, ceramics and combinations thereof. In one optional embodiment, the package or container is composed of a rigid or semi-rigid polymer, optionally polypropylene or polyethylene, and preferably has sufficient rigidity to retain its shape under gravity.

### Exemplary Entrained Polymers

The present application provides active entrained polymers comprising active agents, wherein such polymers can be extruded and/or molded into a variety of desired forms, e.g., container liners, plugs, film sheets, pellets and other such structures.

Optionally, such active entrained polymers may include channeling agents, such as polyethylene glycol (PEG), which form channels between the surface of the entrained polymer and its interior to transmit a selected material (e.g., moisture or air) to the entrained active agent, wherein the channels facilitate release of volatile anti-melanosic material emitted by the active agent (e.g., green tea, green tea extract or other green tea based material). As explained above, entrained polymers may be two phase formulations (i.e., comprising a base polymer and active agent, without a channeling agent) or three phase formulations (i.e., comprising a base polymer, active agent and channeling agent). Entrained polymers are described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth.

Suitable base polymers for use in the invention include thermoplastic polymers, including but not limited to, polyolefins (such as polypropylene and polyethylene), olefin copolymers, polyisoprene, polybutadiene, polybutene, polysiloxane, polycarbonates, polyamides, ethylene-vinyl acetate copolymers, ethylene-methacrylate copolymer, polyvinyl chlorides) (PVCs), polystyrene, polyesters, polyanhydrides, polyacrylianitrile, polysulfones, polyacrylic ester, acrylic, polyurethane and polyacetal, polyhydroxyalkanoates (PHAs), polylactic acid (PLA), polybutylene succinate (PBS), polyhexene, polyvinylpyrrolidone (PVP), copolymers, and combinations thereof.

Suitable channeling agents in the invention include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent 35 can be, for example, a water insoluble polymer, such as a polypropylene oxide-monobutyl ether, which is commercially available under the trade name Polyglykol B01/240, produced by Clariant AG. In other embodiments, the channeling agent could be a polypropylene oxide monobutyl ether, which is commercially available under the trade name Polyglykol B01/20, produced by Clariant AG, polypropylene oxide, which is commercially available under the trade name Polyglykol D01/240, produced by Clariant AG, ethylene vinyl acetate, nylon 6, nylon 66, or any combination of the foregoing.

Entrained polymers with anti-melanosic releasing agents as the active agent are further described below.

### Anti-Melanosic Releasing Agents and Optional Entrained Polymers Incorporating the Same

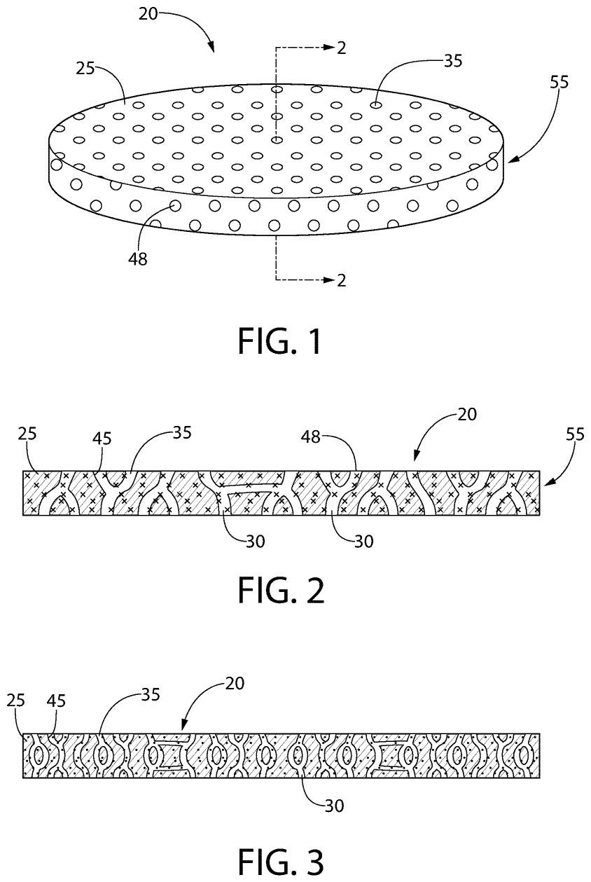

FIGS. 1-10B illustrate entrained polymers 20 and various packaging assemblies formed of entrained polymers according to certain embodiments of the invention. The entrained polymers 20 each include a base polymer 25, optionally a channeling agent 35 and an active agent 30. As shown, the channeling agent 35 forms interconnecting channels 45 through the entrained polymer 20. At least some of the active agent 30 is contained within these channels 45, such that the channels 45 communicate between the active agent 30 and the exterior of the entrained polymer 20 via channel openings 48 formed at outer surfaces of the entrained polymer 20. The active agent 30 can be, for example, any one of a variety of releasing materials, as described herein. While a channeling agent, e.g., 35, may be preferred in some instances, the invention broadly includes entrained polymers that optionally do not include a channeling agent.

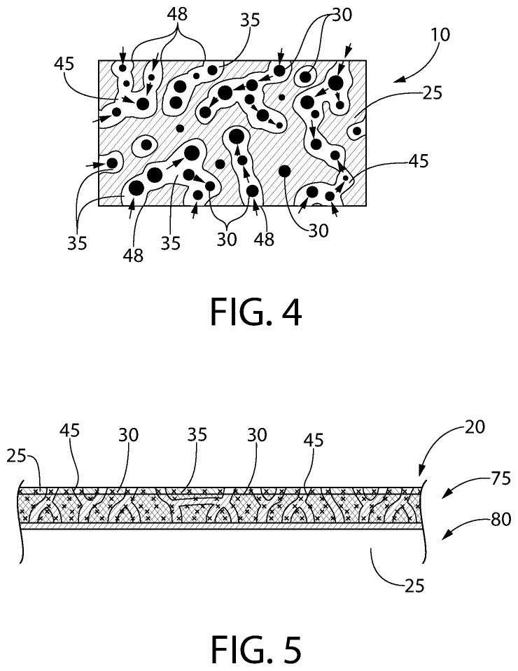

FIG. 4 illustrates an embodiment of an entrained polymer 10 according to an optional embodiment of the invention, in which the active agent 30 is an anti-melanosic releasing agent. The arrows indicate the path of a selected material, for example moisture or another gas, from an exterior of the entrained polymer 10, through the channels 45, to the particles of active agent 30. Optionally, the anti-melanosic releasing agent reacts with or is otherwise triggered or activated by the selected material (e.g., by moisture) and in response releases an anti-melanosic material, preferably in gas or volatile particulate form. Alternatively, the anti-melanosic releasing agent may release an anti-melanosic material without the need for any such triggering or activation, e.g., in a dry environment.

FIG. 5 illustrates an active sheet or film 75 formed of the entrained polymer 20 used in combination with a barrier sheet 80 to form a composite, according to an optional aspect of the invention. The characteristics of the active sheet or film 75 are similar to those described with respect to the plug 55. The barrier sheet 80 may be a substrate such as foil and/or a polymer with low moisture or oxygen permeability. The barrier sheet 80 is compatible with the entrained polymer structure 75 and is thus configured to thermally bond to the active sheet or film 75, when the active sheet or film 75 solidifies after dispensing.

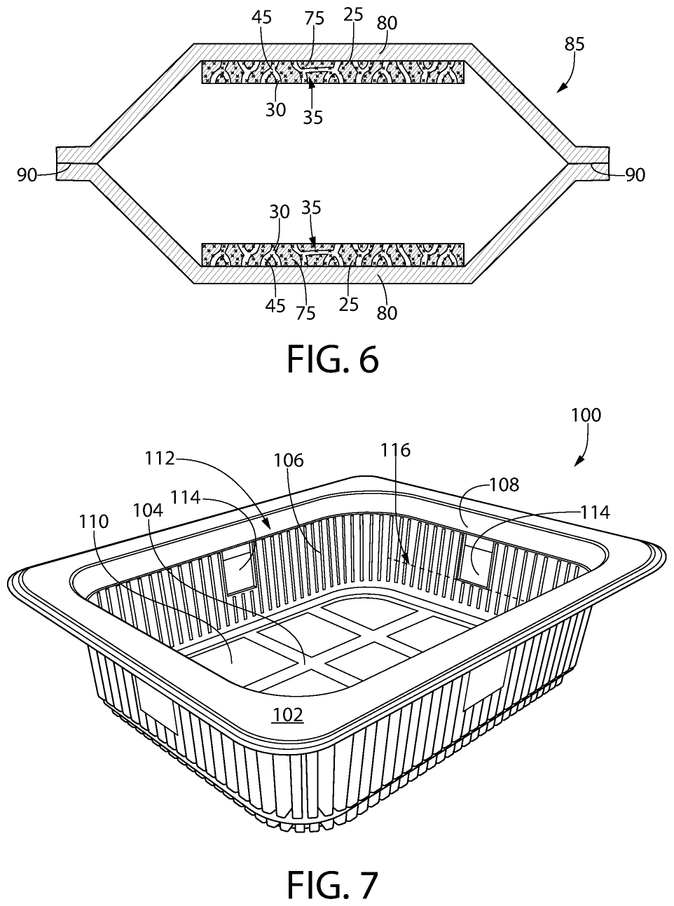

FIG. 6 illustrates an optional embodiment in which the active sheet or film 75 and the barrier sheet 80 are combined to form a packaging wrap having active characteristics at an interior surface formed by the entrained polymer 10 in the active sheet or film 75, and vapor resistant characteristics at an exterior surface formed by the barrier sheet 80. In this embodiment, the active sheet or film 75 occupies a portion of the barrier sheet 80. The methods according to the invention for making the active sheet or film 75 and adhering it to the barrier sheet 80 are not particularly limited.

In one embodiment, the sheets of FIG. 5 are joined together to form an active package 85, as shown in FIG. 6. As shown, two laminates or composites are provided, each formed of an active sheet or film 75 joined with a barrier sheet 80. The sheet laminates are stacked, with the active sheet or film 75 facing one another, so as to be disposed on an interior of the package, and are joined at a sealing region 90, formed about a perimeter of the sealed region of the package interior.

The anti-melanosic releasing agents useful herein include those releasing volatile anti-melanosic components, non-volatile anti-melanosic components and combinations thereof. In one particular aspect, the anti-melanosic releasing material is a carrier or a vehicle for a volatile anti-melanosic components.

The term “volatile anti-melanosic agent” includes any compound that produces a gas and/or gas phase such as vapor of released anti-melanosic component. As will be discussed in greater detail below, the volatile anti-melanosic releasing agent is generally used in a closed system so that the released anti-melanosic component (gas and/or vapor) does not escape.

The term “non-volatile anti-melanosic agent” includes any compound that when it comes into contact with a fluid (e.g., water or the juice from a food product), produces minimal to no vapor of anti-melanosic material.

Preferred features of anti-melanosic agents or anti-melanosic releasing components used according to an aspect of the present invention include any one or more of the following characteristics: (1) they volatize at refrigerated temperatures; (2) they are food safe and edible in finished form; (3) they may be incorporated safely into an entrained polymer formulation or other mechanism for release; (4) they are shelf stable in long term storage conditions; (5) they release the anti-melanosic components at an effective concentration in the package; (6) they do not affect a stored food product organoleptically when they are formulated and configured to achieve a desired release profile within the package; and (7) they are preferably acceptable under applicable governmental regulations and/or guidelines pertaining to food packaging and finished food labeling.

In an optional embodiment, the anti-melanosic releasing agent is a component of an entrained polymer, which is at least two phases and comprises anti-melanosic releasing material and a base polymer. Optionally, the entrained polymer is at least three phases and comprises the anti-melanosic releasing agent, a base polymer, and a channeling agent. The form of the entrained polymer is not limited. Optionally, such entrained polymer is in the form of a film, a sheet, or a plug.

In an optional embodiment, the anti-melanosic releasing agent may be in a raw or crude form. Optionally, the anti-melanosic releasing material comprises Camellia sinensis. Optionally, Camellia sinensis is leaves or buds, or derived from leaves or buds. An example of Camellia sinensis is a green tea (leaves or buds). Optionally, Camellia sinensis is in a crude form or an extract, for example, leaves (crude, processed, or dried) or a tea extract. Optionally, Camellia sinensis or green tea is in a powder form.

Optionally, the base polymer is polypropylene, polyethylene, ethylene vinyl acetate (EVA), or a mixture of at least two of the foregoing.

One non-limiting embodiment of the invention is exemplified using an entrained polymer comprising a green tea powder as the anti-melanosic releasing agent (i.e., finely ground green tea) and a base polymer. Optionally, the entrained polymer is covered with a barrier film on one or both sides to protect the anti-melanosic releasing agent from premature release of the anti-melanosic components. The barrier film is gas or moisture impermeable. When the entrained polymer is placed in a container, the barrier film is removed, allowing the anti-melanosic material to be released.

Optionally, in any embodiment, the entrained polymer may also be covered with a backing film on one or both sides. The backing film may be gas or moisture permeable to allow the released anti-melanosic components to travel to the surrounding environment. For example, a high-density polyethylene film, such as a TYVEK® film (available from DuPont Safety and Construction, Inc., of Delaware, USA), may be used as a gas permeable backing film.

Optionally, the anti-melanosic releasing agent loading level ranges from 0.1% to 70%, optionally from 5% to 60%, optionally from 10% to 50%, optionally from 20% to 40%, optionally from 30% to 35% by weight with respect to the total weight of the entrained polymer.

Optionally, the base polymer ranges from 10% to 70%, optionally from 15% to 60%, optionally from 15% to 50%, optionally from 15% to 40%, optionally from 20% to 60%, optionally from 20% to 50%, optionally from 20% to 40%, optionally from 20% to 35%, optionally from 25% to 60%, optionally from 25% to 50%, optionally from 25% to 40%, optionally from 25% to 30%, optionally from 30% to 60%, optionally from 30% to 50%, optionally from 30% to 45%, optionally from 40% to 60%, optionally from 40% to 50% by weight of the entrained polymer.

Optionally, the optional channeling agent ranges from 2% to 25%, optionally from 5% to 20%, optionally from 5% to 15%, optionally from 5% to 10%, optionally from 8% to 15%, optionally from 8% to 10%, optionally from 10% to 20%, optionally from 10% to 15%, or optionally from 10% to 12% by weight with respect to the total weight of the entrained polymer.

Optionally, an entrained polymer may be a two phase formulation including 20% to 70% by weight of leaves of a green tea in a powder form, 30% to 80% by weight a base polymer (such as polyethylene, polyethylene-based copolymer, polypropylene, ethylene vinyl acetate (EVA), or a mixture). The base polymer is not particularly limited.

Optionally, an entrained polymer may be a three phase formulation including 20% to 60% by weight of leaves of a green tea in a powder form, 30% to 70% by weight a base polymer (such as polyethylene, polyethylene-based copolymer, polypropylene, ethylene vinyl acetate (EVA), or a mixture), and 2-15% by weight a channeling agent (such as a PEG). The base polymer and the channeling agent are not particularly limited.

The methods of producing entrained polymers according to the present invention are not particularly limited. Examples include blending a base polymer and a channeling agent. Production may include extrusion, injection molding, blow molding or vacuum molding using standard molding equipment, as are generally well known. The active agent is blended into the base polymer either before or after adding the channeling agent. All three components are uniformly distributed within the entrained polymer mixture. The entrained polymer thus prepared contains at least three phases.

Optionally, in any of the foregoing embodiments, the anti-melanosic releasing agent entrained polymer is in the form of a film that is disposed within a sealed food package. Optionally, the film may be adhered, e.g., using an adhesive, to an inner surface of the package. Alternatively, the film may be heat staked (without an adhesive) to the inner surface of the package. The process of heat staking film onto a substrate is known in the art and described in detail in U.S. Pat. No. 8,142,603, which is incorporated by reference herein in its entirety. Alternatively, the film may be deposited and adhered to the inner surface of the package via a direct in-line melt process. Alternatively, the film may be placed inside the package without being adhered or affixed to a surface. The size and thickness of the film can vary. In certain embodiments, the film has a thickness of approximately 0.2 mm or 0.3 mm Optionally, the film may range from 0.1 mm to 1.0 mm, more preferably from 0.2 mm to 0.6 mm.

### Exemplary Containers or Packages According to Invention

The entrained polymer containing the anti-melanosic releasing agent of the current invention may be utilized in food packages. The entrained polymer may be attached, adhered, placed, or otherwise included in any container or package via conventional methods. The container or package is used in commerce for food transportation, preservation and storage. The shape or geometry of the container or package is not limited.

FIG. 7 shows an optional package 100 for storing fresh foodstuffs, e.g., seafood, in accordance with certain embodiments of the invention. The package 100 is shown in the form of a plastic tray 102, although other forms and materials are also contemplated as being within the scope of the invention. The tray 102 comprises a base 104, and sidewalls 106 extending vertically from the base 104 leading to a tray opening 108. The base 104 and sidewalls 106 together define an interior 110, e.g. for holding and storing fresh seafood, such as shrimp. The package 100 optionally includes a flexible plastic lidding film 112, which is disposed over and seals the opening 108. It is contemplated and understood that a wide variety of covers or lids may be used to close and seal the opening 108. Optionally, the cover or lid is transparent, such that the interior can be viewed. When a product (e.g., shrimp) is stored within the interior 110, empty space surrounding and above the product is herein referred to as “headspace”.

The package 100 further includes sections of anti-melanosic releasing agent entrained polymer film 114 disposed on the sidewalls 106. In the embodiment shown, there are four sections of such film 114, one section of film 114 per sidewall 106. The film 114 is optionally disposed at or near the top of the sidewall 106, proximal to the opening 108. At least a portion, although optionally most or all of each of the film sections 114 protrude above the midline 116 of the sidewall 106, the midline 116 being centrally located between the base 104 and the opening 108.

Optionally, the entrained polymer film 114 is heat staked to the package (e.g., on the sidewall as described and shown vis-à-vis FIG. 7). Advantageously, heat staking could allow the film to permanently adhere to the sidewall without use of an adhesive. An adhesive may be problematic in some circumstances because it may release unwanted volatiles in the food-containing headspace. Aspects of a heat staking process that may be used in accordance with optional embodiments of the invention are disclosed in U.S. Pat. No. 8,142,603, as referenced above. Heat staking, in this instance, refers to heating a sealing layer substrate on the sidewall while exerting sufficient pressure on the film and sealing layer substrate to adhere the film to the container wall. Optionally, the entrained polymer film 114 is deposited and adhered to the package via a direct in-line melt adhesion process.

In certain embodiments, the anti-melanosic releasing agent entrained polymer film 114 may be connected to the surface of the lidding film 112 (or a lid) that is inside of the container, in place of the film sections 114 on the sidewall(s) 106, or in addition thereto. Alternatively, the anti-melanosic releasing agent entrained polymer film 114 may be incorporated into the composition of the lidding film 112 (or a lid). In general, the polymer entrained with anti-melanosic releasing agent is activated once the barrier film is removed. In one embodiment, the container is sealed in an air tight manner to trap the released anti-melanosic component within the container.

In optional preferred embodiments of the container system, the package or container is closed or covered. Any type of cover may be used which is appropriate with the use of the particular container, such as a cover, a cap, a lid, a plug, a stopper, a cork, a gasket, a seal, a resealable closure, a washer, a liner, a ring, a disk, or any other sealing or closure device. Optionally, the sealing or closure device may be transparent so that the interior can be viewed. The sealing or closure device may optionally be further sealed onto the package using a variety of processes including but not limited to, for example, a lidding sealant, an adhesive, or a heat seal.

In certain embodiments, a controlled release and/or a desired release profile can be achieved by applying a coating to the active agent, e.g., using a spray coater, wherein the coating is configured to release the anti-melanosic component within a desired time frame. The anti-melanosic releasing agent entrained polymer film may have different coatings applied thereon to achieve different release effects. For example, the film may be coated with extended release coatings of varying thicknesses and/or properties to achieve the desired release profile. For example, some active agent will be coated such that it will not begin releasing the anti-melanosic component until after one week, while other active agent will begin release almost immediately. Spray coating technology is known in the art. For example, pharmaceutical beads and the like are spray coated to control the release rate of active ingredient, e.g., to create extended or sustained release drugs. Optionally, such technology may be adapted to apply coatings to the active agent to achieve a desired controlled rate of release of anti-melanosic material.

Alternatively, a controlled release and/or desired release profile may be achieved by providing a layer, optionally on both sides of the film, of a material configured to control exposure. For example, the film may include a polymer liner, made e.g., from low density polyethylene (LDPE) disposed on either side or both sides thereof. The thickness of the film and liner(s) can vary. In certain embodiments, the film is approximately 0.3 mm thick and the LDPE liners on either side are each approximately 0.02 mm to 0.04 mm thick. The LDPE liners may be coextruded with the film or laminated thereon.

Alternatively, a controlled release and/or desired release profile may be achieved by modifying the formulation of the entrained polymer. For example, adjusting the type and the concentration of the channeling agent to provide a desired release rate of anti-melanosic gas.

Any combination of the aforementioned mechanisms may be utilized to achieve desired release rates and release profiles of anti-melanosic material within a container headspace.

### Sorption Material Containing Anti-Melanosic Releasing Agent

Rather than entraining the anti-melanosic releasing agent in a base polymer, the anti-melanosic releasing agent may also be combined with, suspended in, or otherwise incorporated into a sorption material to form an anti-melanosic releasing system. In such instances, the anti-melanosic releasing agent (e.g., green tea leaves, green tea powder or green tea extract) may be mixed with the sorption material.

The anti-melanosic releasing agent loading level in the sorption material ranges from 0.1% to 70%, optionally from 5% to 60%, optionally from 10% to 50%, optionally from 20% to 40%, optionally from 30% to 35%, optionally any sub-ranges thereof by weight with respect to the total weight of the sorption material. The sub-ranges include 1% to 60%, 1% to 40%, 1% to 30%, 1% to 20%, 1% to 10%; 5% to 60%, 5% to 40%, 5% to 30%, 5% to 20%, 5% to 10%; 10% to 60%, 10% to 40%, 10% to 30%, 10% to 20%; 20% to 60%, 20% to 40%, 20% to 30%; 30% to 60%, 30% to 50%, 30% to 40%.

An example of such a sorption material is an absorbent composition of matter as disclosed in U.S. Pat. No. 6,376,034, which is incorporated by reference herein in its entirety. The absorbent composition of matter has an absorbency, the absorbency being defined by weight of liquid absorbed/weight of the absorbent composition of matter. The absorbent composition of matter includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one mineral composition having a second absorbency, the second absorbency being defined by weight of liquid absorbed/weight of the at least one mineral composition, the at least one mineral composition being food safe, the absorbency of the absorbent composition of matter exceeding a sum of the first absorbency and the second absorbency, the absorbent composition of matter being compatible with food products such that the absorbent composition of matter is food safe when in direct contact with the food products. Optionally, the absorbent composition of matter includes additionally: (iii) at least one soluble salt having at least one trivalent cation, the at least one soluble salt having at least one trivalent cation being food safe.

The absorbent material contains from about 10 to 90% by weight, preferably from about 50 to about 80% by weight, and most preferably from about 70 to 75% by weight of a non-crosslinked gel forming polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a mixture of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa. The CMC used in the Examples following was obtained from Hercules, Inc. of Wilmington, Del. (under the tradename B315) or from AKZO Nobel Chemicals Inc. of Stratford, Conn., USA (under the tradename AF3085).

The clay ingredient can be any of a variety of materials and is preferably attapulgite, montmorillonite (including bentonite clays such as hectorite), sericite, kaolin, diatomaceous earth, silica, and other similar materials, and mixtures thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Bentonite used in the Examples following was obtained from American Colloid Company of Arlington Heights, Ill. under the tradename Bentonite AE-H.

Diatomaceous earth is formed from the fossilized remains of diatoms, which are structured somewhat like honeycomb or sponge. Diatomaceous earth absorbs fluids without swelling by accumulating the fluids in the interstices of the structure. Diatomaceous earth was obtained from American Colloid Company.

The clay and diatomaceous earth are present in an amount from about 10-90% by weight, preferably about 20-30% by weight, however, some applications, such as when the absorbent material is to be used to absorb solutions having a high alkalinity, i.e. marinades for poultry, can incorporate up to about 50% diatomaceous earth. The diatomaceous earth can replace nearly all of the clay, with up to about 2% by weight remaining clay.

The trivalent cation is preferably provided in a soluble salt such as derived from aluminum sulfate, potassium aluminum sulfate, and other soluble salts of metal ions such as aluminum, chromium, and the like. Preferably, the trivalent cation is present at about 1 to 20%, most preferably at about 1 to 8%.

The inorganic buffer is one such as sodium carbonate (soda ash), sodium hexametaphosphate, sodium tripolyphosphate, and other similar materials. If a buffer is used, it is present preferably at about 0.6%, however beneficial results have been achieved with amounts up to about 15% by weight.

The mixture of the non-crosslinked gel forming polymer, trivalent cation, and clay forms an absorbent material which when hydrated has an improved gel strength over the non-crosslinked gel forming polymer alone. Further, the gel exhibits minimal syneresis, which is exudation of the liquid component of a gel.

In addition, the combined ingredients form an absorbent which has an absorbent capacity which exceeds the total absorbent capacity of the ingredients individually. It appears that the trivalent cation provides a cross-linking effect on the CMC once in solution, and that the clay swells to absorb and stabilize the gels. However, the mechanism of action and the synergistic effect is not yet clear. Further, as shown by Example D in Table 1, it appears that, in some cases at least, it is not necessary to add trivalent cation. It is thought that perhaps a sufficient amount of trivalent cation is present in the bentonite and diatomaceous earth to provide the crosslinking effect.

The gels formed by the absorbent material of the invention are glass clear (at least when they do not include the anti-melanosic releasing agent), firm gels which may have applications in other areas such as for cosmetic materials. Preferred embodiments of absorbent material formulations that may be mixed with an anti-melanosic releasing material, are set forth in Table 1. It is noted that the formulations in Table 1 do not include the anti-melanosic material, but are presented as illustrative of formulations that may subsequently have the anti-melanosic material mixed into them.

TABLE 1
EXAMPLES OF PREFERRED EMBODIMENTS

| | | | Absorbency-gm/gm | | | |
|---|---|---|---|---|---|---|
| | | | | Expected | | |
| | | | Individual | from | | Actual/ |
| | Ingredient | weight % | Ingredient | Summation | Actual | Expected |
| A | CMC-B315 | 71.3 | 35 | 26.59 | 43.12 | 162.17% |
| | Potassium Aluminum Sulfate | 6.19 | 0 | | | |
| | Bentonite (i.e., Hectorite) | 22.5 | 7 | | | |
| B | CMC-AF3085 | 71.2 | 35 | 27.5 | 53.94 | 196.15% |
| | Potassium Aluminum Sulfate | 6.32 | 0 | | | |
| | Diatomaceous Earth | 20.2 | 12 | | | |
| | Bentonite | 2.25 | 7 | | | |
| C | CMC-AF3085 | 74.4 | 35 | 28.75 | 65.37 | 227.37% |
| | Potassium Aluminum Sulfate | 1.47 | 0 | | | |
| | Diatomaceous Earth | 21.2 | 12 | | | |
| | Bentonite | 2.35 | 7 | | | |
| | Soda Ash (sodium carbonate) | 0.58 | 0 | | | |
| D | CMC-AF3085 | 70 | 35 | 26.12 | 56.74 | 217.23% |
| | Diatomaceous Earth | 27 | 12 | | | |
| | Bentonite | 3 | 7 | | | |
| E | granulated CMC-AF3085 | 70.7 | 35 | 26.37 | 49.17 | 186.46% |
| | Potassium Aluminum Sulfate | 6.14 | 0 | | | |
| | Bentonite | 23.2 | 7 | | | |
| F | CMC-AF3085 | 70.8 | 35 | | | |
| | Potassium Aluminum Sulfate | 6.89 | 0 | 27.35 | 51.79 | 189.36% |
| | Bentonite | 2.23 | 7 | | | |
| | Diatomaceous Earth | 20.1 | 12 | | | |
| G | CMC-AF3085 | 54.0 | 35 | 24.67 | 48.97 | 198.5% |
| | Bentonite | 40.0 | 7 | | | |
| | Alginate | 5.94 | 50 | | | |
| | Calcium Chloride | 0.06 | 0 | | | |
| H | CMC-AF3085 | 75.3 | 35 | 27.98 | 62.51 | 223.4% |
| | Bentonite | 23.2 | 7 | | | |
| | Potassium Aluminum Sulfate | 1.5 | 0 | | | |
| I | CMC-AF3085 | 73.5 | 35 | 27.35 | 64.42 | 235.5% |
| | Bentonite | 23.2 | 7 | | | |
| | Potassium Aluminum Sulfate | 3.3 | 0 | | | |
| J | CMC-B315 | 31.82 | 35 | 18.46 | 32.85 | 177.9% |
| | Diatomaceous Earth | 54.96 | 12 | | | |
| | Bentonite | 10.44 | 7 | | | |
| | Potassium Aluminum Sulfate | 2.78 | 0 | | | |

The method of manufacturing the anti-melanosic system comprising the anti-melanosic releasing material and the sorption material is not particularly limited. The sorption material may be further processed to include the anti-melanosic releasing material before the process of making an article comprising the ingredients. Alternatively, the sorption material may first be fabricated into an article before the anti-melanosic releasing material is incorporated.

As an example, the ingredients for the adsorbent composition of matter are mixed together and then formed into granules. It has been found that preferred embodiments of the invention may be agglomerated by processing without addition of chemicals in a compactor or disk type granulator or similar device to produce granules of uniform and controllable particle size. Granules so formed act as an absorbent with increased rate and capacity of absorption due to the increased surface area of the absorbent. The preferred granule size is from about 75 to 1,000 microns, more preferably from about 150 to 800 microns, and most preferably from about 250 to 600 microns, with the optimum size depending upon the application. Water or another binding agent may be applied to the blend while it is being agitated in the compactor or disk type granulator which may improve the uniformity of particle size. Further, this method is a way in which other ingredients can be included in the composition, such as surfactants, deodorants and anti-microbial agents.

Regardless of the processing method, the anti-melanosic system comprising an anti-melanosic releasing material and a sorption material is used in an anti-melanosic article. Optionally, the article may comprise wells at the bottom of the package 100 of FIG. 7. In such an embodiment, the sorption material, e.g., absorbent material comprising the anti-melanosic releasing agent (e.g., made from green tea) is disposed within the wells. Optionally, a liquid permeable covering, e.g., a non-woven sheet, is provided atop ribs that separate the wells. The food product, e.g., shrimp, may be rest on top of the ribs and liquid permeable covering, thus being suspended above the wells. Any liquid exuded from the food product may drip down into the wells and be absorbed by the absorbent material, which Applicant has found is helpful in preserving the food product. In addition, the anti-melanosic releasing material present within the sorption material, which is not necessarily in physical contact with the food product, emits a volatile component into the package headspace that has the effect of inhibiting melanosis on the food product, e.g., shrimp or other crustacean.

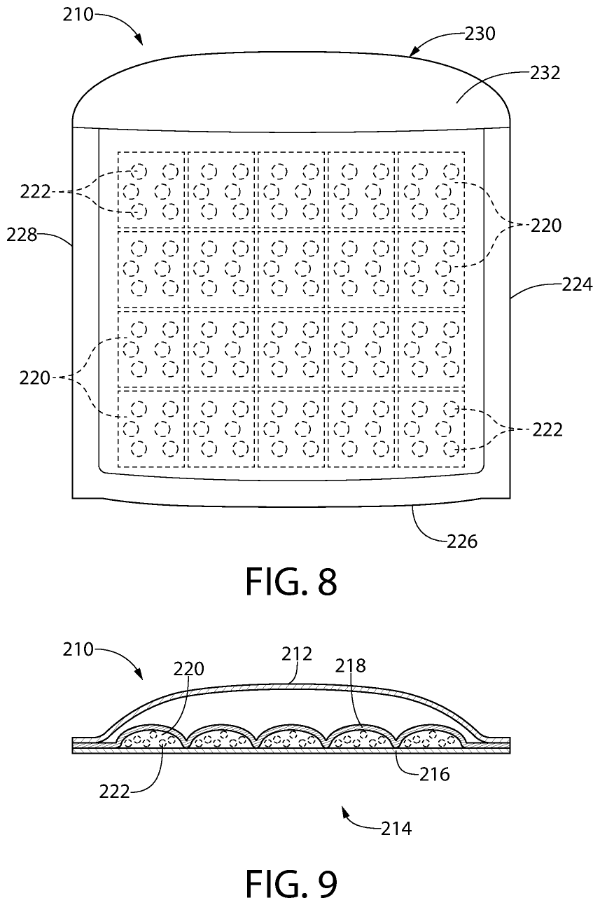

An optional embodiment of a laminated anti-melanosic article structure is illustrated in FIGS. 8 and 9. The structure is especially useful for storage of food products which exude liquids, but may have other applications. In particular, it has been discovered that the structure described hereinbelow provides the advantage of prolonging the preservation or shelf life of food products, such as vegetables, etc., stored therein, even though no visible moisture to be absorbed is present in the structure. The structure may be manufactured with the absorbent material of the present invention or the structure can employ absorbent materials currently known.

The anti-melanosic package 210 comprises a two walled bag or pouch having a first wall 212 of a liquid impervious and preferably transparent thermoplastic such as polyethylene. This layer preferably has a low gas permeability for meat and poultry products but a higher gas permeability for fruit and vegetable products so as to allow ethylene to escape from inside the package and oxygen to move inside the package. The desired specific OTR (oxygen transport rate) of the layer will depend upon the foods to be packaged.

The second wall 214 of the bag is a laminated structure having at least two plies. A first ply 216 is on the outside of the bag and comprises a liquid impervious thermoplastic such as polyester and/or polyethylene laminate. A second ply 218 faces the food product, and comprises a liquid and gas permeable material. This material should be compatible with food items and can be a bi-component non-woven fabric comprised of fibers having a polyester core with a polyethylene sheath. The fabric is made through standard techniques such as by carding the fibers, passing the carded fibers through an oven, and then through nip rolls to “iron” the fabric into a more compact non-woven fabric. In addition, the heat and ironing cause fusion between the fibers. An open mesh fabric is created that is permeable to liquids and gases.

The non-woven permeable inner ply 218 is heat sealed to the polyester/polyethylene outer ply 216 in a pattern so as to form an array of cells 220. Prior to sealing of the plies in a pattern so as to form cells, an absorbent such as the one disclosed herein is placed between the two plies, so that a certain amount of absorbent 222 is trapped within each cell.

The resulting sorbent material can be fashioned into a number of different structures or flexible packages, such as pouches, thermoformed packs, lidding materials, or other packages. To form a pouch or bag as shown in FIG. 8, a large double walled sheath of material can be prepared and then cut to the desired size and heat sealed around three sides 224, 226, 228 to form a bag having an open side 230 with flap 232. The flap 232 can be an overlapping piece of either the polyethylene first wall or the polyester/polyethylene ply. After filling with the product (such as shrimp), the flap 232 can be folded over and heat sealed to the bag. The presence of the array of cells makes possible the formation of various size bags from the double walled sheet having discrete absorbent areas and prevents spillage of absorbent from between the two plies. The two ply second wall can be made by standard techniques as can the two wall sheath of material and the two wall bags.

The permeable or inner ply of the absorbent wall can have a dual layer structure with two layers of the same fibers. The fibers are packed more closely together on the side which is closer to the absorbent and are packed into a more open network on the side closer to the packaged products. In this way the absorbent ply has smaller pores on the side closer to the absorbent and the absorbent is thus unlikely to migrate through the fabric. On the other hand, the ply next to the liquid has larger pores to encourage migration of the liquid therethrough.

While a specific embodiment of a flexible package is described above, the invention is not intended to be limited to the embodiment described. Other embodiments of flexible packages are envisioned utilizing the two ply absorbent fabric described above.

As discussed above, the anti-melanosic releasing agents useful herein include those releasing volatile anti-melanosic components, non-volatile anti-melanosic components and combinations thereof. The sorption material carried anti-melanosic releasing system described herein potentially provides one or both of volatile anti-melanosic components and non-volatile anti-melanosic components, because the latter are potentially able to come into contact with a fluid (e.g., water or the juice from a food product) and be released.

### Method of Preventing or Reducing Melanosis

The anti-melanosic system disclosed herein effectively prevents, inhibits, reduces, or otherwise mitigates melanosis in crustaceans, for example, shrimp. A method of the current invention comprises exposing the crustaceans to an environment comprising an anti-melanosic releasing agent entrained polymer. Optionally, the anti-melanosic effect is achievable without directly physically contacting the active agent or entrained polymer or sorption material with the crustaceans (even if, in some cases, incidental contact occurs).

In one embodiment, the anti-melanosic releasing agent entrained polymer, such as a film, is placed in the vicinity of the crustaceans in a container during transport and storage.

In another embodiment, the anti-melanosic releasing agent carried in a sorption material, such as a sorbent composition of matter, is placed in contact with the crustaceans in a container during transport and storage.

In one embodiment, the anti-melanosic releasing agent entrained polymer, such as a film, is placed in contact with the crustaceans in the presence of a sorbent material in a container during transport and storage.

The anti-melanosic effects of the method and the anti-melanosic system disclosed herein are evaluated by visual inspection for dark spots indicative of melanosis.

The inventors have found that an anti-melanosic system comprising Camellia sinensis provides superior results in preventing and reducing melanosis in shrimp, including without direct physical contact with the shrimp. The invention will be illustrated in more detail with reference to the following Examples, but it should be understood that the invention is not deemed to be limited thereto.

### EXAMPLES

### Example 1

A sample of Chunmee (also known as Chun Mee) Green Tea Organic (Starwest Botanicals, item #401350-01) was ground to a powder form using a coffee grinder. A film was extruded according to the formulation below.

| Film | Formulation |
|---|---|
| 1 | Green Tea: 35% |
| | Exact (Ethylene-based hexene copolymer): 41.37% |
| | PP9074: Polypropylene: 23.63% |
| 2 | Film 1 with a Tyvek ® backing layer on one side |

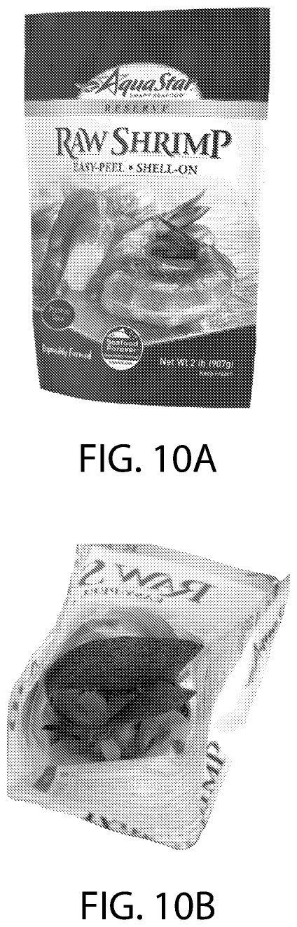

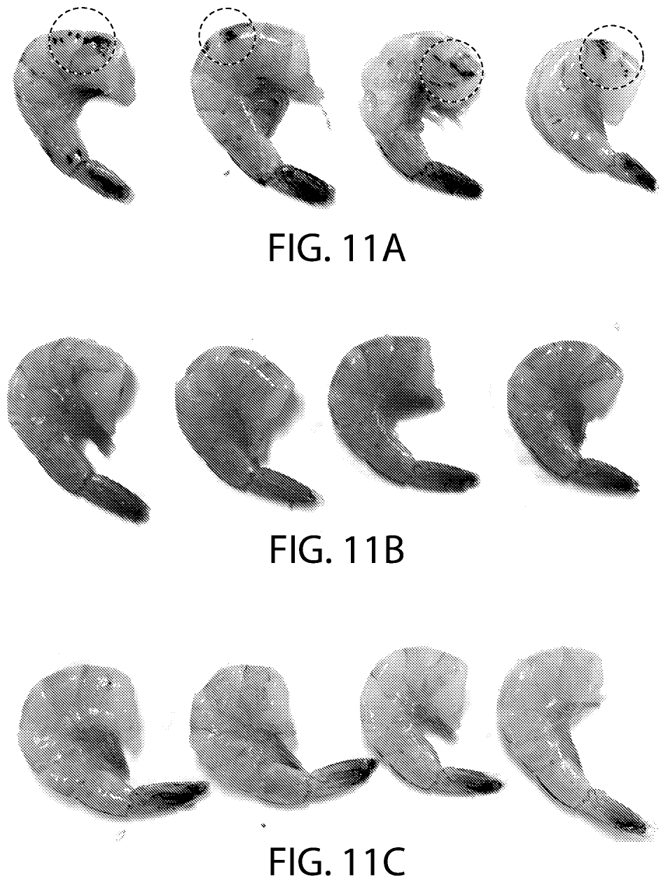

To a 2 lb bag of frozen gulf shrimp (from Aqua Star USA Corp.) was placed Film 1 or 2 (5 g) respectively over the shrimp (FIG. 10). The bags were re-sealed and placed back in a freezer. After 48 hours, the bags were transferred to a refrigerator (4° C.). The visual appearance of the shrimps was evaluated after four days, compared to a control containing no entrained polymer film. In this example, FIG. 11A illustrates the visual appearance of the control samples, FIG. 11B illustrates the visual appearance of the samples having Film 2 and FIG. 11C illustrates the visual appearance of the samples having Film 1.

The results after 4 days indicate that no visible melanosis occurred in the shrimp stored in the bag with optional embodiments of the entrained polymer of the current invention. Further, it was determined that the anti-melanosic effects of the film are not compromised by a Tyvek® backing on one side.

### Example 2

A sample of Chunmee Green Tea Organic (Starwest Botanicals, item #401350-01) was ground to a powder form using a coffee grinder. The green tea grounds were placed in the recessed spaces in the base 104 of a tray 102 (in the wells) comparable to that shown in FIG. 7. A cover made of a non-woven material was placed over the base 104. Shrimp was placed over the cover. A lidding film 112 was disposed over and sealed the opening 108. The tray 102 was stored in a refrigerator or at room temperature.

### Example 3

A sample of Chunmee Green Tea Organic (Starwest Botanicals, item #401350-01) was ground to a powder form using a coffee grinder. The green tea grounds were suspended in and mixed into granules of the adsorbent composition of matter to form an anti-melanosic system. The anti-melanosic system was fashioned into an anti-melanosic absorbent pad as shown in FIGS. 8 and 9. Fifteen (15) trays containing approximately 8 oz of three different types of shrimp were prepared, as set forth in Table 2, below. Three trays of each type of shrimp were placed over the anti-melanosic absorbent pad. Two trays of each type were maintained as a control and not placed on the anti-melanosic adsorbent pad. All 15 trays were placed into a refrigerator and maintained at refrigerated temperature for 5 days.

TABLE 2
Shrimp samples.

| Sample Group | Acronym | Description |
|---|---|---|
| Sample 1 | RHSO | raw, headless, shell-on |
| Sample 2 | PDTO | raw, peeled, deveined, tail-on |
| Sample 3 | CPDTO | cooked, peeled, deveined, tail-on |

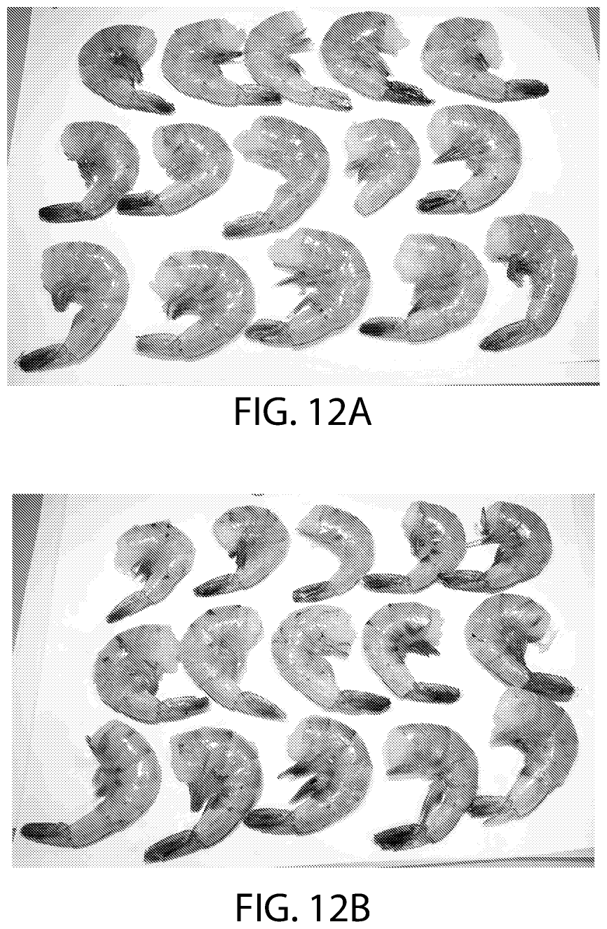

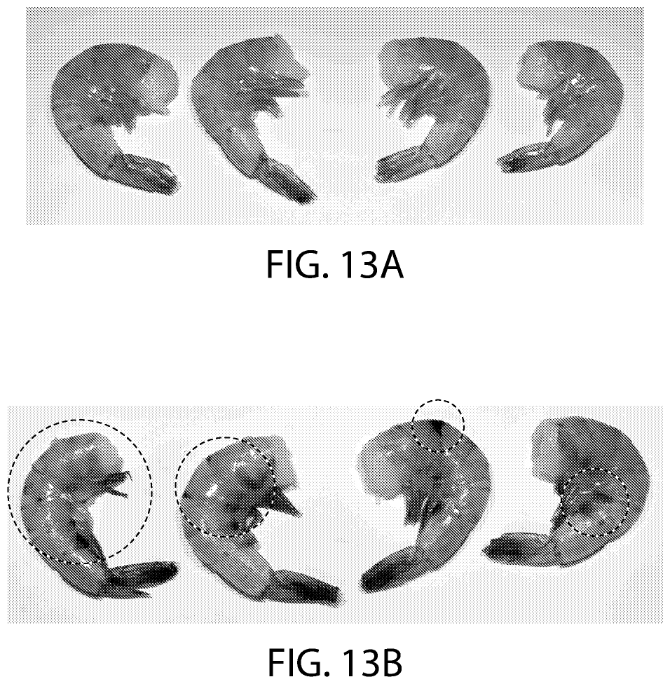

Each group of samples underwent daily organoleptic observation compared with its respective control sample group. Photographic results on day 5 of Sample Group 1 (raw, headless, shell-on shrimp) are shown in FIGS. 12A, 12B, with close up views in 13A and 13B. All shrimp with the tested anti-melanosis solution (FIG. 12A and close up view in FIG. 13A) were consistently lighter in color than the control samples (FIG. 12B and close up view in FIG. 13B). The shrimp of test Sample Group 1 (FIGS. 12A and 13A) showed virtually no black spots or few black spots on day 5 as compared to the corresponding control sample (FIGS. 12B and 13B), which showed a number of pronounced black spots of melanosis, indicating that the shrimp were undergoing degradation.

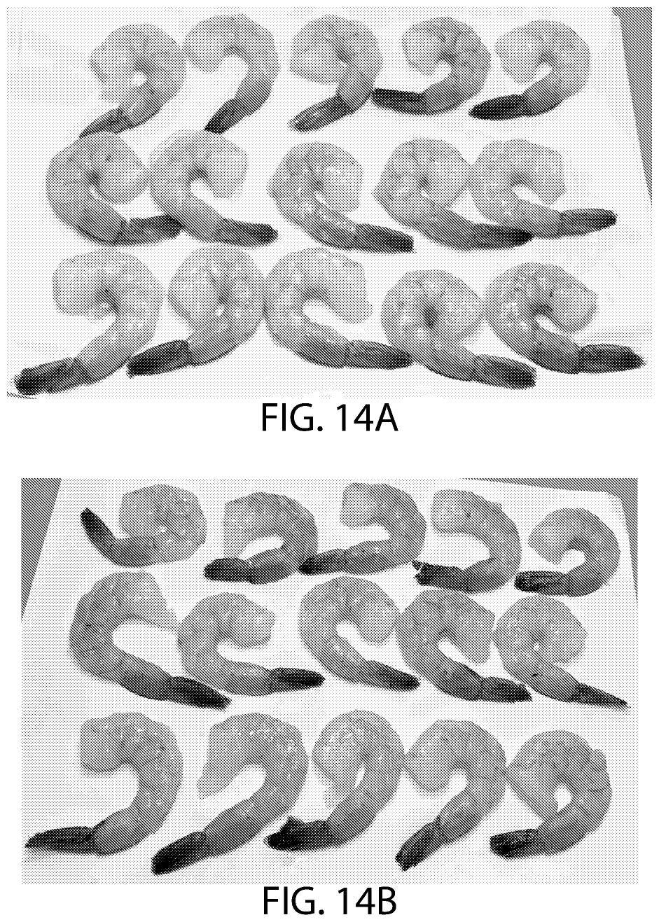

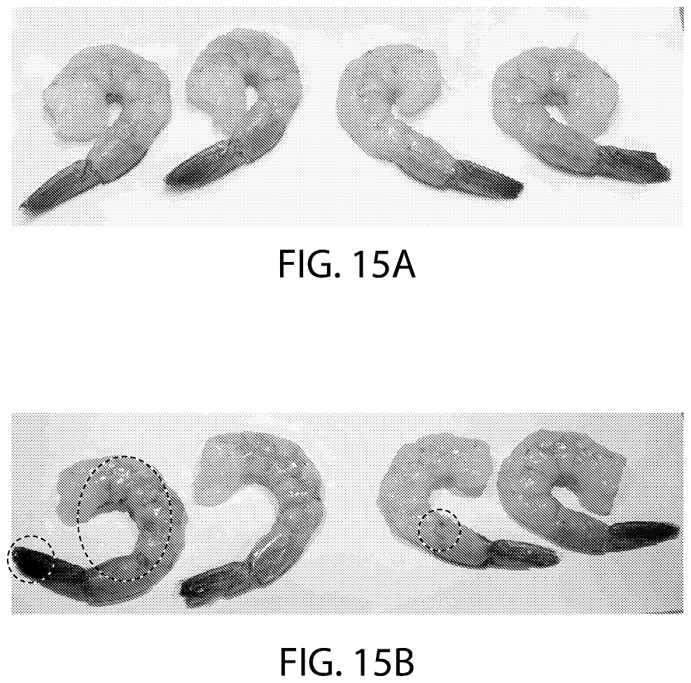

FIGS. 14 and 15 show the results for Sample Group 2 (raw, peeled, deveined, tail-on shrimp). All of the shrimp in test Sample Group 2 (FIGS. 14A and 15A) were also consistently lighter in color than the control shrimp samples (FIG. 14B and close up view in FIG. 15B). FIG. 15B shows melanosis spots on the control samples formed 2-5 days after refrigeration whereas the test samples virtually had no melanosis, as shown in comparative FIG. 15A.

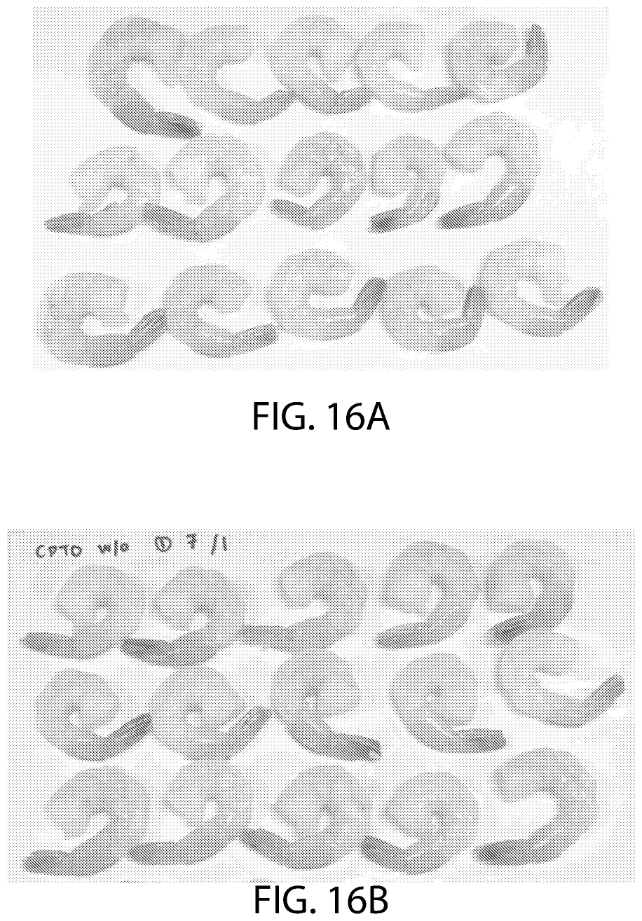

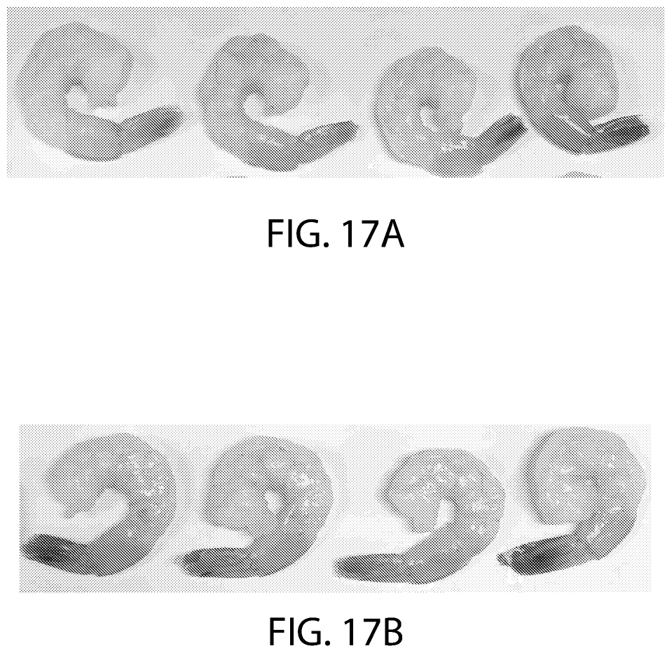

For Sample Group 3 (cooked, peeled, deveined, tail-on shrimp), there was no significant difference seen in melanosis spots between the test shrimp (FIGS. 16A and 17A) and the controls (FIGS. 16B and 17B). However, the tails on all the shrimp of the test samples (FIG. 17A) were much lighter in color that than the tails on the shrimp on the control trays (FIG. 17B). These test results indicate that the anti-melanosis compounds of the invention help to inhibit melanosis for 4-5 days, at least on the tails, after shrimp are thawed (at refrigerated conditions), even after the shrimp have been cooked.

While the invention has been described in detail and with reference to specific examples thereof, it will be apparent to one skilled in the art that various changes and modifications can be made therein without departing from the spirit and scope thereof.

What is claimed is:

1. An anti-melanosic system comprising a container and entrained polymer inside the container, the entrained polymer comprising:
i. a base polymer; and
ii. an anti-melanosic releasing agent;
wherein the anti-melanosic releasing agent comprises at least one of Camellia sinensis leaves and Camellia sinensis buds, the system further comprising a lidding film as a closure device for the container.

2. The anti-melanosic system of claim 1, wherein the anti-melanosic releasing agent comprises green tea leaves.

3. (canceled)

4. (canceled)

5. The anti-melanosic system of claim 2, wherein the entrained polymer is a film having a thickness of from 0.1 mm to 1.0 mm.

6. (canceled)

7. (canceled)

8. The anti-melanosic system of claim 5, wherein the anti-melanosic releasing agent is from 20% to 80% by weight with respect to the total weight of the entrained polymer.

9. (canceled)

10. (canceled)

11. (canceled)

12. (canceled)

13. (canceled)

14. (canceled)

15. (canceled)

16. (canceled)

17. (canceled)

18. The anti-melanosic system of claim 5, wherein the lidding film, is an oxygen permeable lidding film configured to facilitate bi-directional exchange of oxygen through the lidding film.

19. (canceled)

20. (canceled)

21. (canceled)

22. The anti-melanosic system of claim 2, comprising at least one crustacean stored inside the container, the anti-melanosic system having an effect of inhibiting melanosis in the at least one crustacean.

23. (canceled)

24. A method of preventing or reducing melanosis in at least one crustacean, comprising the step of exposing the at least one crustacean to an anti-melanosic releasing agent, wherein the anti-melanosic releasing agent comprises at least one of Camellia sinensis leaves and Camellia sinensis buds and/or an extract thereof, wherein the step of exposing the at least one crustacean to the anti-melanosic releasing agent does not require physical contact between the anti-melanosic releasing agent and the at least one crustacean.

25. The method of claim 24, wherein the at least one crustacean is shrimp.

26. (canceled)

27. The method of claim 24, wherein the anti-melanosic releasing agent generates a volatile component in space adjacent to the at least one crustacean that effectuates prevention or reduction of melanosis on the at least one crustacean, without physical contact between the anti-melanosic releasing agent and the at least one crustacean.

28. The method of claim 24, wherein the anti-melanosic releasing agent is provided in an entrained polymer comprising a base polymer and the anti-melanosic releasing agent.

29. The method of claim 28, wherein the anti-melanosic releasing agent comprises green tea leaves.

30. The method of claim 28, wherein the at least one of Camellia sinensis leaves and Camellia sinensis buds is in a powder form.

31. The method of claim 29, wherein the entrained polymer is an extruded film having a thickness in the range of from 0.1 mm to 1.0 mm.

32. The method of claim 31, wherein the base polymer is from 10% to 70% by weight with respect to the total weight of the entrained polymer and the anti-melanosic releasing agent is from 20% to 80% by weight with respect to the total weight of the entrained polymer.

33. The method of claim 28, wherein the base polymer is polypropylene, polyethylene, polyisoprene, polyhexene, polybutadiene, polybutene, polysiloxane, polycarbonate, polyamide, ethylene-vinyl acetate copolymer, ethylene-methacrylate copolymer, poly(vinyl chloride), polystyrene, polyester, polyanhydride, polyacrylianitrile, polysulfone, polyacrylic ester, acrylic, polyurethane, polyacetal, polyhydroxyalkanoates (PHA), polylactic acid (PLA), polybutylene succinate (PBS), polyhexene, polyvinylpyrrolidone (PVP), a copolymer, or a combination thereof.

34. The method of claim 28, wherein the anti-melanosic releasing agent comprises Chunmee green tea leaves.

35. A method of preventing or reducing melanosis in at least one crustacean, comprising the step of exposing the at least one crustacean to an anti-melanosic releasing agent, wherein the anti-melanosic releasing agent comprises at least one of Camellia sinensis leaves and Camellia sinensis buds and/or an extract thereof, wherein the anti-melanosic releasing agent generates a volatile component in space adjacent to the at least one crustacean that effectuates prevention or reduction of melanosis on the crustacean, without physical contact between the anti-melanosic releasing agent and the crustacean.

36. The method of claim 35, wherein the at least one crustacean comprises shrimp.

37. The method of claim 35, wherein the anti-melanosic releasing agent is provided in an entrained polymer comprising a base polymer and the anti-melanosic releasing agent.

38. The method of claim 37, wherein the anti-melanosic releasing agent comprises green tea leaves.

39. The method of claim 37, wherein the at least one of Camellia sinensis leaves and Camellia sinensis buds is in a powder form.

40. The method of claim 37, wherein the entrained polymer is an extruded film having a thickness in the range of from 0.1 mm to 1.0 mm.

41. The method of claim 40, wherein the base polymer is from 10% to 70% by weight with respect to the total weight of the entrained polymer and the anti-melanosic releasing agent is from 20% to 80% by weight with respect to the total weight of the entrained polymer.

42. The method of claim 37, wherein the base polymer is polypropylene, polyethylene, polyisoprene, polyhexene, polybutadiene, polybutene, polysiloxane, polycarbonate, polyamide, ethylene-vinyl acetate copolymer, ethylene-methacrylate copolymer, poly(vinyl chloride), polystyrene, polyester, polyanhydride, polyacrylianitrile, polysulfone, polyacrylic ester, acrylic, polyurethane, polyacetal, polyhydroxyalkanoates (PHA), polylactic acid (PLA), polybutylene succinate (PBS), polyhexene, polyvinylpyrrolidone (PVP), a copolymer, or a combination thereof.

43. The method of claim 37, wherein the anti-melanosic releasing agent comprises Chunmee green tea leaves.
